(19) United States
(12) Patent Application Publication
(10) Pub. No.: US 2023/0047087 A1
(43) Pub. Date: Feb. 16, 2023

(54) CONNECTION ARRANGEMENT FOR A SCREENING APPARATUS

(71) Applicant: SANDVIK SRP AB, Svedala (SE)

(72) Inventors: Narayan DHAKAL, Lahti (FI); Hannu ERKOMAA, Kerava (FI); Niko TUOMINEN, Kouvola (FI)

(21) Appl. No.: 17/796,182

(22) PCT Filed: Jan. 29, 2020
(86) PCT No.: PCT/EP2020/052083

§ 371 Date: Jul. 28, 2022

(51) Int. Cl. B07B 1/42

(52) U.S. Cl. CPC B07B 1/42

(57) ABSTRACT

A connection arrangement for releasably securing a vibratory apparatus onto a screening apparatus, wherein the vibratory apparatus includes a first vibratory mechanism and a second vibratory mechanism capable of introducing vibration. The connection arrangement includes at least one support plate having at least one indentation and a side plate having at least two indentations. The at least one support plate and the side plate are attachable to the screening apparatus and cooperate with each other to form, in terms of the indentations, respective enclosures for holding the first vibratory mechanism and the second vibratory mechanism.

### FIELD OF INVENTION

The present invention relates to a connection arrangement for releasably securing a vibratory apparatus onto a screening apparatus, and in particular, although not exclusively, to a connection arrangement for releasably mounting a vibratory apparatus having at least two vibratory mechanisms.

### BACKGROUND ART

A connection arrangement or ‘connecting assembly’ is used to attach a vibratory apparatus onto a screening apparatus. It may be required that a vibratory apparatus generates a linear motion where the motion has a linear stroke. Such a vibratory apparatus typically includes two identical parallelly arranged vibratory mechanisms (simply referred to as “mechanism” below), which may be positioned on top of a screening apparatus (simply referred herein to as “screen”), it is understood that the installation of vibratory mechanisms on top of a screen body ensures easy maintenance. The mechanism at its both ends is releasably mounted to the side wall of a screen frame.

FIG. 1 shows a conventional design of a connection arrangement for releasably securing a vibratory apparatus on a screen, wherein the connection arrangement includes, on either side wall of the screen, a common integral connection plate for fixing both mechanisms. The connection plate has two circular holes for receiving a respective retainer of the mechanisms.

Based on this construction, the entire vibratory apparatus is pre-assembled and is then lifted in its entirety and fastened to the screen frame. For maintenance, in case that one mechanism needs to be repaired or replaced, it is required to disassemble the whole vibratory apparatus (including both mechanisms) from the screen and repair or replace the defected mechanism. That is, it is required to lift at one time both mechanisms, which are typically heavy in weight. This is unsafe and unnecessary, as disassembling the whole vibratory apparatus causes too much of a workload, also re-assembling after mechanism repair would be time consuming.

Accordingly, what is required is a connection arrangement that addresses the above problems.

### SUMMARY OF THE INVENTION

It is an objective of the present invention to provide a connection arrangement that enables swift and safe assembly and disassembly of a vibratory mechanism.

In order to generate desired vibration to a screen and achieve a required motion stroke or G-force, a vibratory apparatus is configured to be heavy in weight as it includes eccentric mass, rotation shaft, motors, and gear drive etc, for example, this is the case for the purpose of heavy-duty screening of high bulk density materials. Therefore, it would be favourable, during installation or maintenance of a vibratory apparatus, to avoid lifting of the entire vibratory apparatus or disassembling all components thereof from the screen frame.

The objectives are achieved by dividing a single connection plate into two or multiple pieces of plates, instead of a using an integral connection plate, to mount a vibratory apparatus. In particular, the present application utilizes a common side plate arranged to cooperate with one or two support plates to form respective enclosure(s) for retaining a first vibratory mechanism and a second vibratory mechanism. The common side plate is used to secure the mechanisms from top, and to fasten the mechanisms in place and prevent them from movement.

Concerning the installation of a vibratory apparatus on a screen, it is required to fix a large number of clamping means (such as bolts or threaded couplings, or other fasteners) between the vibratory apparatus and side walls of a screen. In a conventional situation, this would have been strenuous, because it is required to align a number of small holes on the respective vibratory apparatus and screen and to bring them into precisely matched position, as fixing the clamping means has to be carried out when the heavy vibratory mechanism is raised in air. In accordance with the present solution, the requirement to lift the complete heavy vibratory apparatus in air during aligning and fixing the clamping means is not necessary. Other advantages include that the mounting of support plate is separate from and performed before lifting a mechanism, and the mechanism is lifted individually one after another.

Concerning the maintenance of a vibratory apparatus, if only a single mechanism needs repair, the second mechanism doesn't need to be lifted, dismounted or disturbed, consequently, the processing is simplified with less work burden, and the interference from the other mechanism is eliminated.

By the present solution, it is aimed to sequence the conventional installation or disassembling of a vibratory apparatus. During the installation operation, fixing plates on a screen and lifting vibratory mechanisms are now performed in sequence, and during the disassembling operation, only a portion of the clamping means associated with the side plate is needed to be removed (there is no disruption to the clamping means associated with the support plate). Thus, the installation or disassembling process is optimised. Besides, as the weight to be lifted is reduced to half, no heavy units need to be lifted, thus the installation process becomes safer, and the risk of accidents is reduced. Further, smaller lifting capacity (e.g. of a crane) is needed, overall maintenance time is reduced, and advantageously, operation costs are reduced.

According to a first aspect of the present invention, there is provided a connection arrangement for releasably securing a vibratory apparatus to a screening apparatus, wherein the vibratory apparatus comprises a first vibratory mechanism and a second vibratory mechanism capable of introducing vibratory action when actuated, the connection arrangement is characterized by:
at least one support plate configured to support the vibratory apparatus, each support plate comprises at least one indentation that is distributed along a longitudinal direction of the support plate;
a side plate comprising at least two indentations that are distributed along a longitudinal direction of the side plate and facing a same side (i.e. opening toward the same side of the side plate), the side plate is attachable to the screening apparatus and/or to the at least one support plate;
wherein the at least one support plate is attachable to the screening apparatus, and cooperative with the side plate to form in terms of the indentations of the at least one support plate and of the side plate respective enclosures for holding the first vibratory mechanism and the second vibratory mechanism.

It is understood that each enclosure defines a space for holding a retainer of a mechanism. The side plate and the at least one support plate are to be mounted to the screening apparatus in such a way that an indentation of the side plate is partly ‘aligned’ with an indentation of a support plate to form an enclosure.

In the solution, the support plates and side plate are of a planar structure or have at least one surface portion that is planar, this permits them to be placed next to the screen side wall and mounted thereon. The side plate and/or support plate may be arranged on an inner or outer side of the screen walls. The planar portion extends in a longitudinal direction to a certain length that may be chosen so that a number of or at least one row of continuous holes can be incorporated on the extended planar portion along the longitudinal direction. The plurality of holes ensures ideal distribution of forces, so that force is kept minimal and evenly distributed on individual clamping means (e.g. bolts). The number of holes may be chosen dependent on the desired force originated from the vibration.

The support plate may have on its upper edge a shape of polygonal line or curve, where interior angles or curvature thereof may correspond to the design details of the retainer of a mechanism. The size or width of support plates may be identical or may differ, it may be slightly greater than to the width of a mechanism retainer and shall be able to absorb compressive or tensile forces which act on the connection arrangement.

The size or width of indentation of the support plate and of the side plate is chosen such that it is accessible by the mechanism retainer, in other words, it corresponds to but is slightly larger than the maximum width of the mechanism retainer.

In one specific implementation, the support plate is formed as a female part that can be embedded into the opening of the side plate, preferably perfectly wedged within the opening to leave exactly a space for the mechanism retainer. The connection arrangement may comprise two separate support plates, each support plate comprising one indentation. Using two individual support plates makes it possible to position each support plate within a respective indentation of the side plate.

The two separate support plates may be configured to be embedded in the respective indentations of the side plate, wherein the side plate and the two support plates are positioned in the same vertical plane. Thereby, an integral and rigid connection arrangement can be achieved.

The two separate support plates may be separated by a portion of the side plate along the longitudinal direction of the side plate. The side plate includes a middle portion that can be fixed to the screen, to ensure the strength and rigidity of the connection arrangement when mounted to the screen.

Optionally, the connection arrangement comprises a single support plate, which includes two indentations that are distributed along a longitudinal direction of the side plate and face a same side, wherein the side plate is configured to be arranged side-by-side with and parallel to the support plate, thus, the side plate is arranged adjacent to the support plate. This arrangement enables easy installation of the first vibratory mechanism and the second vibratory mechanism in their right positions, and precise relative position of the mechanisms relative to each other shall be maintained in order to generate a linear stroke.

Optionally, the first vibratory mechanism and the second vibratory mechanism are positioned in parallel and configured to generate a motion having a linear stroke.

In relation to the central line between the rotation shafts, the side plate extends shorter in one direction (e.g. to the front, along the longitudinal direction) than in the counter direction (to the rear), i.e. the side plate is non-symmetrical in shape. The connection arrangement is thereby optimised in structure design and force distribution.

The side plate comprises a plurality of holes at a bottom area for receiving respective mounting means to mount the side plate to the screening apparatus. The plurality of holes may be equally spaced and are spread continuously from a front side to a rear side of the side plate.

The enclosures can have a circular form or a polygonal form. This form is pre-defined in order to match the profile of retainer.

The side plate comprises a plurality of holes on the periphery of respective enclosures for receiving respective mounting means to fix the first vibratory mechanism and the second vibratory mechanism. This enforces the structure when the vibratory mechanisms are installed, for example, a part of tensile force can be transmitted via the side plate to the screen.

Optionally, the connection arrangement comprises a further side plate and at least one further support plate that are attachable to the screening apparatus and spaced in a wide direction (i.e. along shaft axis of the vibratory mechanism) apart from and arranged parallel to the side plate. The further side plate and the at least one further support plate have substantially the same configuration in structure as the side plate and the at least one support plate respectively. The further side plate cooperates with the at least one further support plate to form respective enclosures for holding the first vibratory mechanism and the second vibratory mechanism at a further side of the screening apparatus along a wide direction.

According to a second aspect of the present invention, there is provided a screening apparatus for processing stones or ores or other mineral material, comprising a vibratory apparatus, a first vibratory mechanism and a second vibratory mechanism; and a connection arrangement according to any of afore-described embodiments, for securing the vibratory apparatus to the screening apparatus.

According to a further aspect of the present invention, there is provided a method for arranging a vibratory apparatus to a screening apparatus that comprises a screen frame, wherein the vibratory apparatus comprises a first vibratory mechanism and a second vibratory mechanism, the method comprises the steps of:
providing a support means on the screen frame, the support means adapted to support the first vibratory mechanism and the second vibratory mechanism;
providing a side plate that is attachable to the screen frame, wherein the side plate is cooperative with the support means to form respective enclosures for holding the first vibratory mechanism and the second vibratory mechanism; and
securing the side plate to the screen frame.

It is understood that the support means can be an individual support plate (separate from screen side wall), or an integral part of a screen side wall, e.g. in the form of a seat on the side wall having two concave and arc-shaped portion facing upwards.

The method can further include the steps of lifting the first vibratory mechanism and arranging it on the support means; and lifting the second vibratory mechanism and arranging it on the support means.

The method further comprises securing the first vibratory mechanism and the second vibratory mechanism to the support means, this permits the support means to carry tensile forces applied from the mechanism.

Optionally, the method further comprises securing the first vibratory mechanism and the second vibratory mechanism to the side plate after the first vibratory mechanism and the second vibratory mechanism having been lifted and arranged on the support means.

Although the solution is described for a vibratory apparatus having two vibratory mechanisms, it can be applicable for connecting multiple vibratory mechanisms.

### BRIEF DESCRIPTION OF DRAWINGS

A specific implementation of the present invention will now be described, by way of example only, and with reference to the accompanying drawings in which:

FIG. 1 is an elevation view of an existing side plate;

FIG. 2 is an elevation view of a connection arrangement according to a first implementation of the present invention;

FIG. 3 is an exploded view of the connection arrangement of FIG. 2;

FIG. 4 is a perspective view of a connection arrangement according to a second implementation of the present invention;

FIG. 5 is an exploded view of the connection arrangement of FIG. 4;

FIG. 6 is a partial perspective view showing a step of the process of assembling a vibratory apparatus, wherein a first mechanism is placed on screen side walls;

FIG. 7 is a partial perspective view showing a step of the process of assembling a vibratory apparatus, wherein a second mechanism is placed on screen side walls;

FIG. 8 is a perspective view of a screening apparatus wherein a vibratory apparatus has been arranged on a connection arrangement according to a first implementation of the present invention;

FIG. 9 is a perspective view of a screening apparatus of FIG. 8, wherein the protection housing of a vibratory apparatus has been removed.

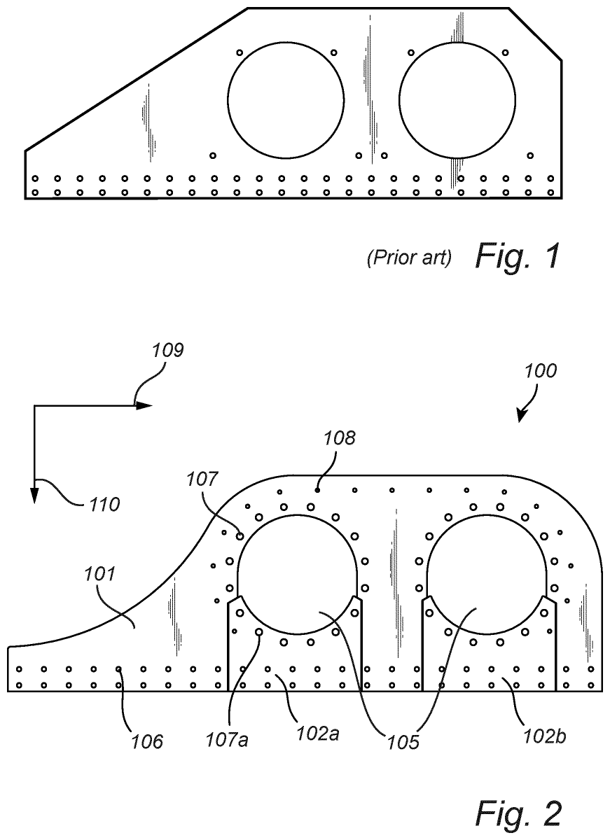

### DETAILED DESCRIPTION OF THE INVENTION

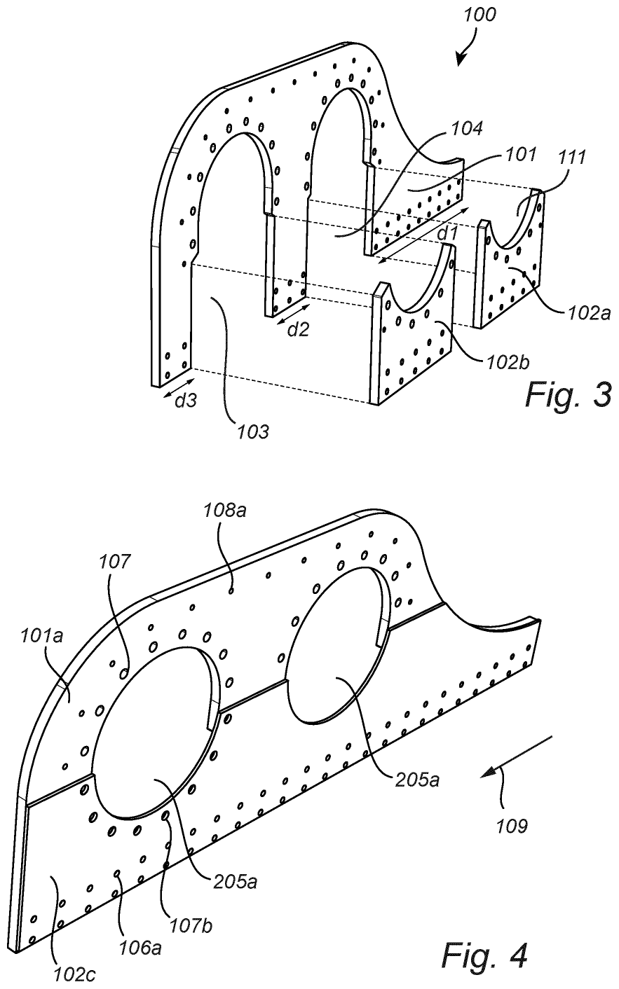

The present invention will be described in greater detail and in a non-limiting way with reference to the enclosed embodiments. FIG. 2 shows a connection arrangement 100 according to a first embodiment for releasably securing a vibratory apparatus (excitor assembly). An exploded view of the connection arrangement 100 is provided in FIG. 3. The connection arrangement 100 includes two support plates 102a 102b positioned upright for supporting vibratory mechanisms to be mounted, the support plates have two rows of continuous holes on the bottom side for fixing the support plates to a screen wall. On the upper side the support plates are formed as concave and arc-shaped, holes 107a are provided on the periphery of top area for fixing a mechanism.

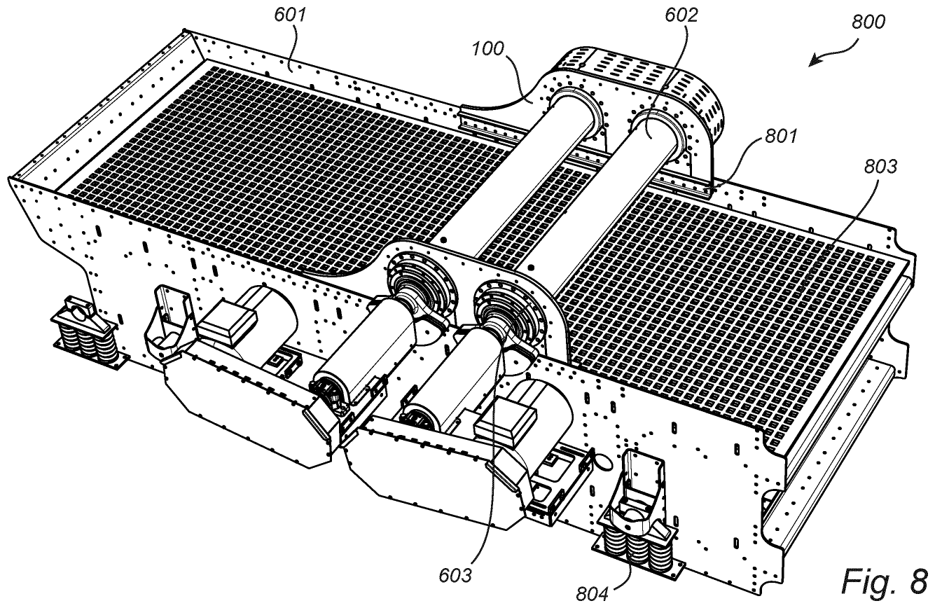

The connection arrangement 100 further includes a side plate 101 extending in longitudinal direction 109, which includes two indentations or openings 103 and 104 (FIG. 3) that face in a direction downward 110 and are distributed along longitudinal direction 109 of the side plate. Also holes 107 are provided on the periphery of the indentations for fixing the retainers 603 of respective mechanisms. In addition, a plurality of holes 108 are provided on an outer edge of the side plate for receiving bolts and the like to secure a safety cover (shown in FIG. 8) that prevents contact from freely rotating units (such as the shaft).

The indentations 103, 104 divide the bottom area of side plate 101 into three sections or legs, rendering the side plate resembling an elephant in shape as seen from the lateral side, where the front section extends along a longitudinal direction substantially longer than the middle section and rear section (i.e. d1>d2 and d3, see FIG. 3), and may decrease gradually in height. The three sections extend respectively on bottom edges to certain lengths (indicated as d1, d2, d3), where at least one row of connection holes 106 are formed on the bottom edge along longitudinal direction 109, through which corresponding bolts can be inserted for securing the side plate to the screening apparatus 800, the number and size of the holes being selected mainly in accordance with the desired vibration force. This configuration assures a rigid and reliable mechanical connection between mechanisms and screen.

As shown in FIG. 2, the two support plates 102a, 102b may be placed parallel with the side plate in a common plane and embodied in the indentations 103, 104 in a tight fit in longitudinal direction 109. During assembling of the mechanisms, the indentation of the side plate can be aligned with the support plate 102a, 102b, such that the upward facing indentations 111 together with the downward facing indentations form two circular holes 105 for accommodating mechanism retainers 603, respectively. The dimension of the circular holes 105 substantially corresponds to and matches the dimension of a mechanism retainer.

Further, an edge stiffening steel bar 801 in the form of L-section (FIG. 8) may be provided at the bottom to clamp the side plate and support plates to the screen side walls.

A further connection arrangement 701a is provided to mount the mechanisms on the other side. Generally, the axis of each mechanism is tangential to the plane of side plates.

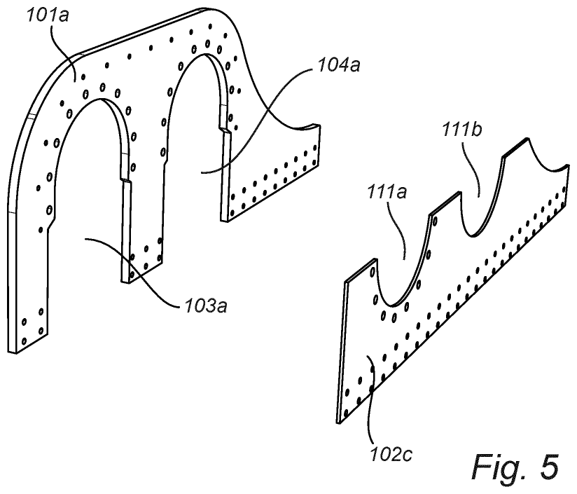

A second embodiment of a connection arrangement is shown and describes with reference to FIG. 4. An exploded view thereof is provided in FIG. 5. The connection arrangement includes a single support plate 102c for holding the vibratory mechanisms from bottom and has two concave and arc-shaped portions 111a, 111b that face upwards and are spaced apart from each other by a distance. The connection arrangement has an elongate form extending from the front end to the rear end, wherein in the rear it may have a reduced height, and two rows of continuous holes 106a are provided in the longitudinal direction for receiving bolts of a clamping construction. By means of the clamping construction, consisting of bolts and co-acting nut bodies, the connection arrangement can be retained on the screen. Holes 107, 107b are provided on the periphery of the indentations for fixing the retainers of respective mechanisms.

Likewise, the connection arrangement includes a side plate 101a which has similar configuration as the aforementioned embodiment. Further, the side plate 101a is provided with a plurality of holes 108a on an outer edge of the side plate for receiving bolts and the like to secure a safety cover (shown in FIG. 8) that prevents contact from freely rotating units. As shown in FIG. 5, side plate 101a includes two indentations 103a, 104a that face the same direction 110 to divide the bottom area of side plate 101a into three sections or legs, thereby making the lateral profile of the side plate look like an elephant, wherein the three sections extend along a longitudinal direction respectively on bottom edges to certain lengths. Two rows of connection holes are formed on bottom edge, through which corresponding bolts can be inserted for securing the side plate to a screen.

The side plate 101a is positioned parallel and directly next to the support plate 102c, i.e. positioned adjacent and leaning against the support plate 102c. The side plate 101a shall be aligned with the support plate 102c such that two circular holes 205a are formed by the indentations for accommodating mechanism retainers respectively.

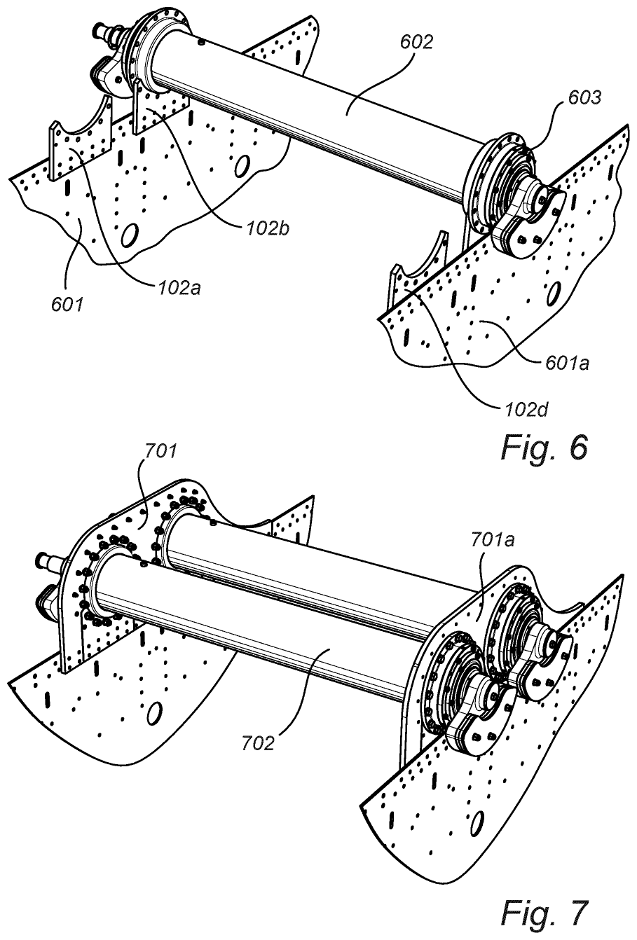

The process of assembling a vibratory apparatus is partly illustrated in FIGS. 6 to 7 in accordance with a partial perspective view. Firstly, support plates 102a, 102b, 102d are mounted to screen walls 601, 601a of the screen, this can be done by fastening screw bolts or welding, then a first mechanism 602 is lifted and placed on the concave portion of support plate 102b, followed by a second mechanism 702 being lifted and placed on another support plate 102a. Subsequently a side plate 701 is attached from top to the screen 800, the indentations of the side plate as acting as a guide slot that guides the side plate to move downwards, during which movement, the retainer 603 of the mechanism 602 is engaged within an indentation 103. The movement terminates until the upper border of indentation 103 contacts or abuts the retainer 603.

Next, a further side plate 701a is attached over the retainers on a screen side wall 601a at the other side. Finally, the mechanisms are fastened to the side plates, as well as to the support plates, by clamping construction, e.g. by releasable means such as bolts and co-acting nuts, or by welding.

The disassembly of the vibratory apparatus from the screen is a reversed process of the above steps, including dismounting side plates, subsequently removing the individual vibratory mechanism that needs repairment or replacement.

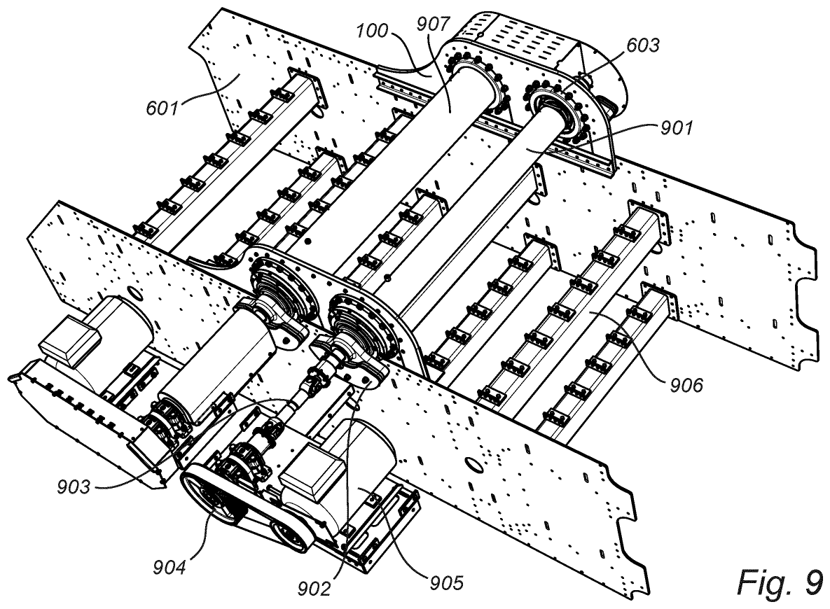

Referring to FIGS. 8 and 9, a screen 800 is illustrated equipped with a vibratory mechanism that introduces a linear motion onto the screen. The screen includes a screen support frame carrying a sieve 803, and the support frame includes two parallel upright side walls 601 coupled, via a bracket containing damping springs 804, to a base. A pair of vibratory mechanisms 602 are secured to side walls by means of connection arrangement 100 positioned on the inner side of the screen side walls. In another embodiment, the connection arrangement 100 may be fastened to the outer side of the screen side walls 601, 601a.

More details of the screening apparatus of FIG. 8 can be seen in FIG. 9, wherein the protection housing 907 of a vibratory apparatus has been removed. The vibratory mechanism includes a retainer 603 and a vibration generating unit (having a shaft 901) mounted at the retainer 603, retainer 603 being rigidly mounted to connection arrangements 100. Two rotation shafts 901 of the mechanisms are located in a common plane and disposed substantially perpendicular to the planes of the side walls 601, 601a. A reinforcing strip 801 is used to increase the stiffness of the connection.

The retainer 603 may comprise a bearing, such as roller bearing. The mechanism shaft 901 is coupled to an inner ring of the bearing, while the connection arrangement 100 is coupled to the outer ring of the bearing. Eccentric masses 902 are arranged on the shaft at the outside of the screen side wall and are configured such that when rotating in counter directions they generate a linear motion.

The mechanism shaft includes a lateral coupling to a cardan drive shaft 903, which is again in driving connection to a drive wheel 904 driven via a belt by an electric motor 905.

Additional housing or tube 907 may be included to protect people from being injured by the rotation, they may be fixed onto the connection arrangement 100 or mechanism retainer.

1. A connection arrangement for releasably securing a vibratory apparatus to a screening apparatus, wherein the vibratory apparatus includes a first vibratory mechanism and a second vibratory mechanism arranged to introduce vibratory action when actuated, the connection arrangement comprising:
at least one support plate configured to support the vibratory apparatus, each support plate including at least one indentation distributed along a longitudinal direction of the support plate; and
a side plate including at least two indentations distributed along a longitudinal direction of the side plate and facing a same side, the side plate being attachable to the screening apparatus and/or to the at least one support plate, wherein the at least one support plate is attachable to the screening apparatus in cooperation with the side plate to form, in terms of the indentations of the at least one support plate and of the side plate respective enclosures for holding the first vibratory mechanism and the second vibratory mechanism.

2. The connection arrangement according to claim 1, comprising two separate support plates, each support plate having one indentation.

3. The connection arrangement according to claim 2, wherein the two separate support plates are configured to be embedded in the respective indentations of the side plate, the side plate and the two support plates being positioned in the same vertical plane.

4. The connection arrangement according to claim 2, wherein the two separate support plates are separated by a portion of the side plate along the longitudinal direction of the side plate.

5. The connection arrangement according to claim 1, comprising a single support plate which includes two indentations that are distributed along the longitudinal direction of the side plate and facing a same side, wherein the side plate is configured to be arranged side by side with and parallel to the support plate.

6. The connection arrangement according to claim 1, wherein the first vibratory mechanism and the second vibratory mechanism are positioned in parallel and configured to generate a motion having a linear stroke.

7. The connection arrangement according to claim 1, wherein, in relation to a central line between rotation shafts of the screening apparatus, the side plate is shorter in one direction than in a counter direction.

8. The connection arrangement according to any one of the claim 1, wherein the side plate includes a plurality of holes at a bottom area arranged for receiving respective mounting means to mount the side plate to the screening apparatus, the plurality of holes being equally spaced and spread continuously from a front side to a rear side of the side plate.

9. The connection arrangement according to claim 1, wherein the enclosures are of a circular form or a polygonal form.

10. The connection arrangement according to claim 1, wherein the side plate includes a plurality of holes around respective enclosures arranged for receiving respective mounting means to fix the first vibratory mechanism and the second vibratory mechanism.

11. The connection arrangement according to claim 1, further comprising a further side plate and at least one further support plate that are attachable to the screening apparatus, and spaced apart from and arranged parallel to the side plate along a wide direction, wherein the further side plate and the at least one further support plate are substantially of the same configuration in structure as the side plate and the at least one support plate respectively, the further side plate being cooperative with the at least one further support plate to form respective enclosures for holding the first vibratory mechanism and the second vibratory mechanism at a further side of the screening apparatus along a wide direction.

12. A screening apparatus arranged for processing stones or ores or other mineral material, the screening apparatus comprising:
a vibratory apparatus including a first vibratory mechanism and a second vibratory mechanism; and
a connection arrangement according to claim 1, arranged for securing the vibratory apparatus to the screening apparatus.

13. A method for arranging a vibratory apparatus to a screening apparatus having a screen frame, wherein the vibratory apparatus includes a first vibratory mechanism and a second vibratory mechanism, the method comprising the steps of:
providing a support means on the screen frame, the support means being arranged to support the first vibratory mechanism and the second vibratory mechanism (702);
providing a side plate that is attachable to the screen frame, wherein the side plate is cooperative with the support means to form respective enclosures for holding the first vibratory mechanism and the second vibratory mechanism; and
securing the side plate to the screen frame.

14. The method according to claim 13, further comprising the steps of:
lifting the first vibratory mechanism and arranging it on the support means; and
lifting the second vibratory mechanism and arranging it on the support means.

15. The method according to claim 13, further comprising the steps of:
securing the first vibratory mechanism and the second vibratory mechanism to the support means; and
securing the first vibratory mechanism and the second vibratory mechanism to the side plate after the first vibratory mechanism and the second vibratory mechanism having been lifted and arranged on the support means.
